(19) United States
(12) Patent Application Publication
(10) Pub. No.: US 2012/0102453 A1
(43) Pub. Date: Apr. 26, 2012

(54) MULTI-DIMENSIONAL OBJECTS

(75) Inventors: Raymond Patch, Redmond, WA (US); Rajeev Chauhan, Issaquah, WA (US)

(73) Assignee: Microsoft Corporation, Redmond, WA (US)

(21) Appl. No.: 12/908,888

(22) Filed: Oct. 21, 2010

(51) Int. Cl. G06F 9/44; G06F 17/30

(52) U.S. Cl. 717/108; 707/792; 707/783; 707/E17.055; 707/E17.045

(57) ABSTRACT

Architecture that enables a software object to be a multi-dimensional object by associating additional dimensions to the object. The object, in addition to the actual data dimension, is now provided with inherent object dimensions that include, but are not limited to, a localization dimension, security dimension, version dimension, personalization dimension, and attributes dimension, for example. The actual data dimension and one or more inherent object dimensions can be added, changed, or modified in realtime. A mapping component maps object relationships between an in-memory form and a tabular form storable in a database. An application programming interface facilitates interaction with the object, and the actual data dimension, and the one or more inherent object dimensions.

### CROSS-REFERENCE TO RELATED APPLICATIONS

This application is related to U.S. patent application Ser. No. ______ (Atty Dkt No. 330475.01) entitled “PERSONALIZED OBJECT DIMENSION” and filed ______, the entirety of which is incorporated by reference.

### BACKGROUND

Objects are used extensively in software environments as a mechanism for bringing together data components and the procedures that operate on those data components. Objects are single-dimensional entities, where the object value or “actual data” is the single dimension. The actual data, also referred to as metadata, helps the system work with the application and a particular object.

However, as software and hardware become more complex, and provide additional sophistication for performing tasks, the rudimentary object and single dimension becoming a limiting factor not only for local usage but for interacting with cloud applications and services.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables a software object to be a multi-dimensional object by associating additional dimensions to the object. A user is now provided with inherent object dimensions or capabilities that do not require custom code and which abstract the underlying data store. The inherent object dimensions include, but are not limited to, a localization dimension, security dimension, version dimension, personalization dimension, and attributes dimension.

The architecture is a multi-dimension object system that includes an object in association with an actual data dimension, and a dimension component that includes one or more inherent object dimensions in association with the object. The actual data dimension and one or more inherent object dimensions can be added, changed, or modified in realtime. The architecture can also include a mapping component that maps object relationships between an in-memory form, and a tabular form storable in a database, and an application programming interface for interacting with the object, the actual data dimension, and the one or more inherent object dimensions.

The inherent object dimensions include a localization dimension that facilitates storage of the object in one or more locations and retrieval of the object from the one or more locations, a security dimension that enables management of access to the object and object properties according to a specific user, a version dimension that enables storage and retrieval of the object based on version information, a personalization dimension that stores personal information of a user in association with the object, and an attributes dimension that enables attribution to a property of the object, as well as other dimensions, as desired. The object can be searched according to at least one of the actual data dimension or an inherent object dimension.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented multi-dimension object system in accordance with the disclosed architecture.

FIG. 2 illustrates an alternative embodiment of a multi-dimension object system.

FIG. 3 illustrates a computer-implemented multi-dimension object method in accordance with the disclosed architecture.

FIG. 4 illustrates further aspects of the method of FIG. 3.

FIG. 5 illustrates a block diagram of a computing system that facilitates the creation, association, and utilization of multi-dimensional objects in accordance with the disclosed architecture.

### DETAILED DESCRIPTION

The disclosed architecture provides additional dimensions to the existing dimension of actual data. The object can be stored in the “cloud” and persisted in relational databases, for example, is accessible through web services. The object can be persisted with additional dimensions to provide more than a typical “in-memory” object. The intrinsic data contained within the object itself is considered the first dimension, and additional data and/or metadata make up the additional dimensions.

The additional (new) dimensions include, but are not limited to, a localized dimension, personalized dimension, security dimension, version dimension, attributes dimension, and so on. The architecture provides the developer with inherent object dimensions that do not require custom code, but yet abstract the underlying data store.

In all cases, the developer simply loads the object from the object namespace (directory) and uses the object as if it was created within the current application, like any other object. The difference is what happens on the object namespace server. In all cases, the namespace server returns the object in one of its many dimensions depending on how the object was stored.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

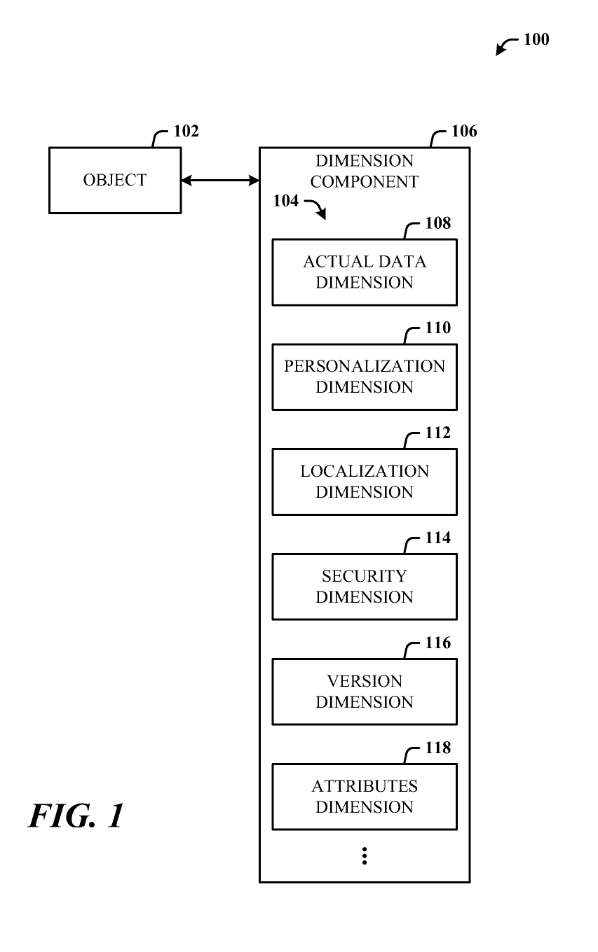

FIG. 1 illustrates a computer-implemented multi-dimension object system 100 in accordance with the disclosed architecture. The system 100 includes an object 102 in association with multiple dimensions 104, as provided by a dimension component 106. The multiple dimensions 104 include an actual data dimension 108, and additional inherent object dimensions. The inherent object dimensions include a personalization dimension 110, a localized dimension 112, a security dimension 114, a version dimension 116, an attributes dimension 118, and other dimensions, as desired.

The localization dimension 112 facilitates storage of the object 102 in one or more locations and retrieval of the object 102 from the one or more locations. The security dimension 114 enables management of access to the object 102 and object properties according to a specific user. The version dimension 116 enables storage and retrieval of the object 102 based on version information. The personalization dimension 110 stores personal information of a user in association with the object 102. The attributes dimension 118 enables attribution to a property of the object 102.

Generally, if the object 102 has been localized (using the localization dimension 112, then the object 102 is returned back in the language/culture of the caller. If the object 102 has access control rights enabled (using the security dimension 114), then only authorized callers may access the object 102. The same technique applies the other inherent objects, as well.

More specifically, the localization dimension 112 provides the ability to store and retrieve objects in one more locales. The user (e.g., developer) does not need to use resource files to localize objects. However, capabilities are provided to import resource files and map translated values to objects.

The security dimension 114 provides functionality to allow access control lists (ACLs) to be constructed to control access to objects and object properties by only certain users and groups. The architecture provides application programming interfaces (APIs) to construct the ACLs for each object and for authorizing access against the specific ACL.

The version dimension 116 provides a mechanism to store and retrieve objects based on a specific version, and also enables the ability to derive a history of changes made to the object 102.

The personalization dimension 110 provides the ability to collect elements of data that build up an increasingly accurate identity for a user which can be used as a central point for attaching object data. Therefore, the personalization dimension 110 can inherently serve up objects that can be used to personalize the user experience.

In one specific implementation, the architecture provides a central way to store, retrieve and update .Net objects (by Microsoft Corporation) of any type from any system. Additionally, the disclosed architecture reduces the amount of boilerplate code that would otherwise need to be written to update object data in a persistent data store (e.g., RDBMS-relational database management systems) and enables access to data that is mastered in other systems.

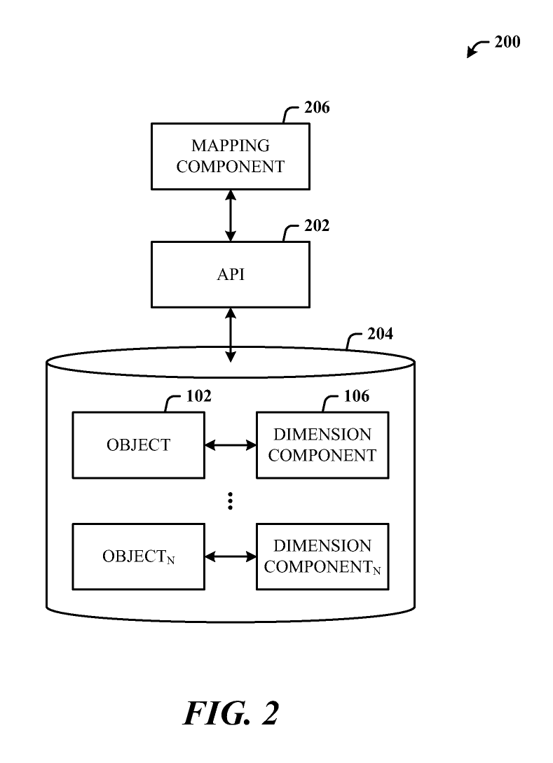

FIG. 2 illustrates an alternative embodiment of a multi-dimension object system 200. The system 200 includes the object 102 and dimension component 106 of FIG. 1, but additionally, an API 202 that facilitates access and interaction to an underlying data store 204 that persists the object 102 and associated dimensions of the dimension component 106, as well as other objects and associate object dimensions. Thus, object-specific dimensions (or capabilities) can be provided that are consistent across all object interactions. In other words, the API (a programming interface) facilitates interacting with the object 102, the actual data dimension, and the one or more inherent object dimensions of the dimension component 106. A mapping component 206 facilitates the mapping of object relationships between an in-memory form of the object and associated dimensions and a tabular form of the object and associated dimensions for storage in the data store 204 (e.g., a relational database).

As a general, but not limited, summary, the disclosed architecture introduces the utilization of at least inherent object dimensions. Object relationship mapping can be accomplished into a relational database (e.g., SQL-structured query language) and object directory. An object API is provided for accessing and interacting with the objects and associated dimensions.

Additionally, the ability to add, change, and/or modify the object 102, actual data dimension and inherent object dimensions within a network and calling applications can be performed in realtime.

The cost of development is significantly reduced since objects can be designed, stored, retrieved, and dimensioned within minutes by developers with lesser skills than is otherwise needed today to achieve the same functional results. Moreover, the risk of development is low since the system is simple to use, and provides any enterprise and Internet capabilities for scale, performance, and reliability.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

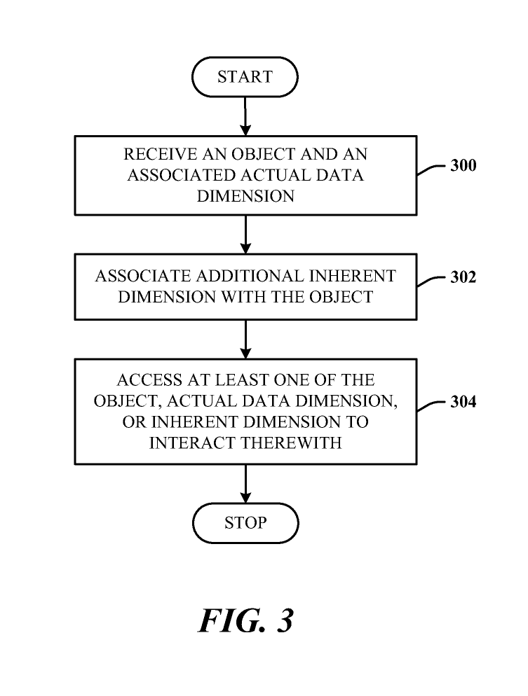

FIG. 3 illustrates a computer-implemented multi-dimension object method in accordance with the disclosed architecture. At 300, an object and an associated actual data dimension are received. At 302, an additional inherent dimension is associated with the object. At 304, at least one of the object, actual data dimension, or inherent dimension is accessed to interact therewith.

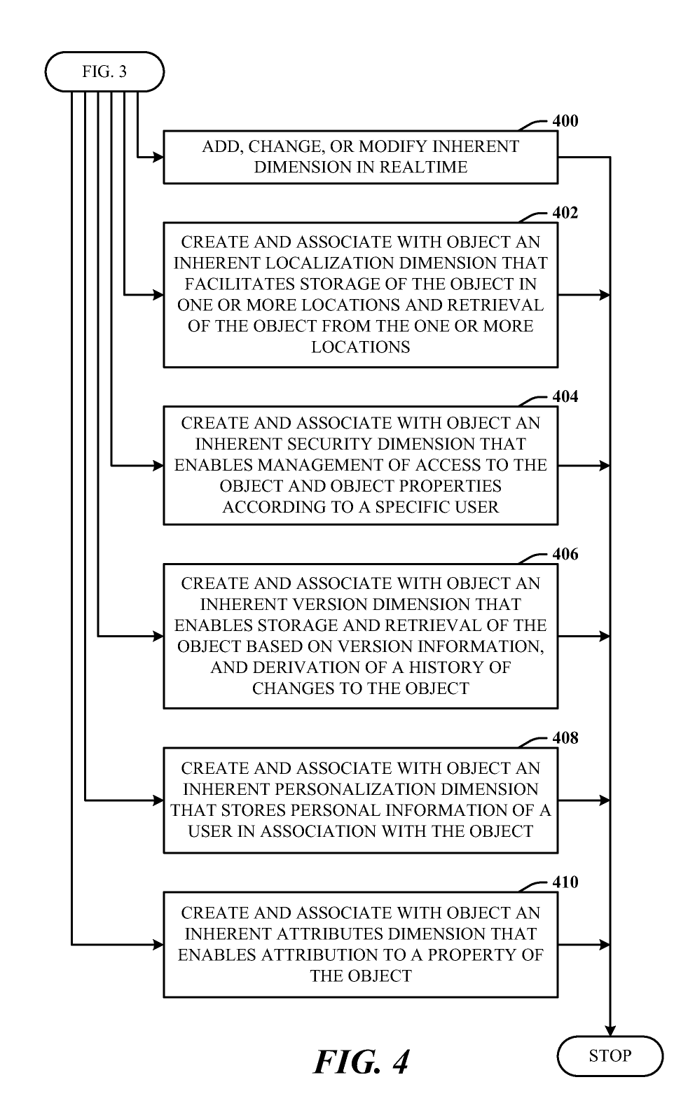

FIG. 4 illustrates further aspects of the method of FIG. 3. Note that the flow indicates that each block can represent a step that can be included, separately or in combination with other blocks, as additional aspects of the method represented by the flow chart of FIG. 3. At 400, the inherent dimension can be added, changed, or modified in realtime. At 402, an inherent localization dimension that facilitates storage of the object in one or more locations and retrieval of the object from the one or more locations. At 404, an inherent security dimension is created and associated with the object that enables management of access to the object and object properties according to a specific user. At 406, an inherent version dimension is created and associated with the object that enables storage and retrieval of the object based on version information, and derivation of a history of changes to the object. At 408, an inherent personalization dimension is created and associated with the object that stores personal information of a user in association with the object. At 410, an inherent attributes dimension is created and associated with the object that enables attribution to a property of the object.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

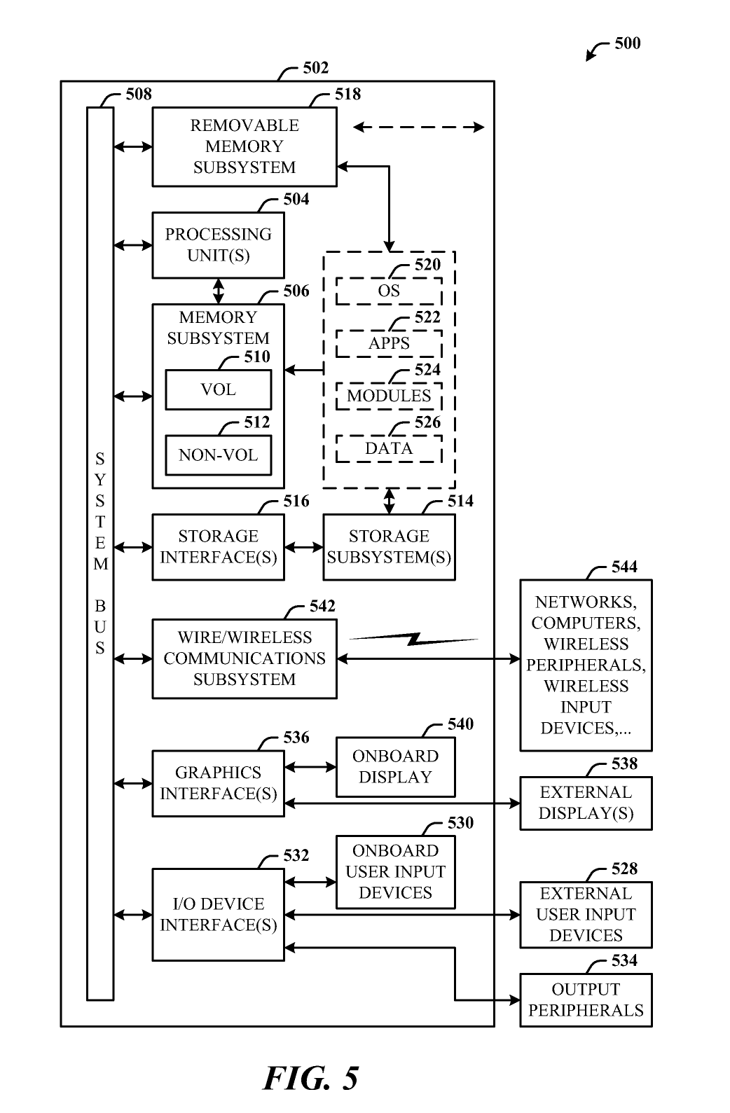

Referring now to FIG. 5, there is illustrated a block diagram of a computing system 500 that facilitates the creation, association, and utilization of multi-dimensional objects in accordance with the disclosed architecture. In order to provide additional context for various aspects thereof, FIG. 5 and the following description are intended to provide a brief, general description of the suitable computing system 500 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 500 for implementing various aspects includes the computer 502 having processing unit(s) 504, a computer-readable storage such as a system memory 506, and a system bus 508. The processing unit(s) 504 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 506 can include computer-readable storage (physical storage media) such as a volatile (VOL) memory 510 (e.g., random access memory (RAM)) and non-volatile memory (NON-VOL) 512 (e.g., ROM, EPROM, EEPROM, etc.). A basic input/output system (BIOS) can be stored in the non-volatile memory 512, and includes the basic routines that facilitate the communication of data and signals between components within the computer 502, such as during startup. The volatile memory 510 can also include a high-speed RAM such as static RAM for caching data.

The system bus 508 provides an interface for system components including, but not limited to, the system memory 506 to the processing unit(s) 504. The system bus 508 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 502 further includes machine readable storage subsystem(s) 514 and storage interface(s) 516 for interfacing the storage subsystem(s) 514 to the system bus 508 and other desired computer components. The storage subsystem(s) 514 (physical storage media) can include one or more of a hard disk drive (HDD), a magnetic floppy disk drive (FDD), and/or optical disk storage drive (e.g., a CD-ROM drive DVD drive), for example. The storage interface(s) 516 can include interface technologies such as EIDE, ATA, SATA, and IEEE 1394, for example.

One or more programs and data can be stored in the memory subsystem 506, a machine readable and removable memory subsystem 518 (e.g., flash drive form factor technology), and/or the storage subsystem(s) 514 (e.g., optical, magnetic, solid state), including an operating system 520, one or more application programs 522, other program modules 524, and program data 526.

The one or more application programs 522, other program modules 524, and program data 526 can include the entities and components of the system 100 of FIG. 1, the entities and components of the system 200 of FIG. 2, and the methods represented by the flowcharts of FIGS. 3 and 4, for example.

Generally, programs include routines, methods, data structures, other software components, etc., that perform particular tasks or implement particular abstract data types. All or portions of the operating system 520, applications 522, modules 524, and/or data 526 can also be cached in memory such as the volatile memory 510, for example. It is to be appreciated that the disclosed architecture can be implemented with various commercially available operating systems or combinations of operating systems (e.g., as virtual machines).

The storage subsystem(s) 514 and memory subsystems (506 and 518) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 502 and includes volatile and non-volatile internal and/or external media that is removable or non-removable. For the computer 502, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 502, programs, and data using external user input devices 528 such as a keyboard and a mouse. Other external user input devices 528 can include a microphone, an IR (infrared) remote control, a joystick, a game pad, camera recognition systems, a stylus pen, touch screen, gesture systems (e.g., eye movement, head movement, etc.), and/or the like. The user can interact with the computer 502, programs, and data using onboard user input devices 530 such a touchpad, microphone, keyboard, etc., where the computer 502 is a portable computer, for example. These and other input devices are connected to the processing unit(s) 504 through input/output (I/O) device interface(s) 532 via the system bus 508, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 532 also facilitate the use of output peripherals 534 such as printers, audio devices, camera devices, and so on, such as a sound card and/or onboard audio processing capability.

One or more graphics interface(s) 536 (also commonly referred to as a graphics processing unit (GPU)) provide graphics and video signals between the computer 502 and external display(s) 538 (e.g., LCD, plasma) and/or onboard displays 540 (e.g., for portable computer). The graphics interface(s) 536 can also be manufactured as part of the computer system board.

The computer 502 can operate in a networked environment (e.g., IP-based) using logical connections via a wired/wireless communications subsystem 542 to one or more networks and/or other computers. The other computers can include workstations, servers, routers, personal computers, microprocessor-based entertainment appliances, peer devices or other common network nodes, and typically include many or all of the elements described relative to the computer 502. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 502 connects to the network via a wired/wireless communication subsystem 542 (e.g., a network interface adapter, onboard transceiver subsystem, etc.) to communicate with wired/wireless networks, wired/wireless printers, wired/wireless input devices 544, and so on. The computer 502 can include a modem or other means for establishing communications over the network. In a networked environment, programs and data relative to the computer 502 can be stored in the remote memory/storage device, as is associated with a distributed system. It will be appreciated that the network connections shown are exemplary and other means of establishing a communications link between the computers can be used.

The computer 502 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented multi-dimension object system, comprising:
an object in association with an actual data dimension;
a dimension component that includes one or more inherent object dimensions in association with the object; and
a processor that executes computer-executable instructions associated with the object and dimension component.

2. The system of claim 1, wherein the dimension component includes a localization dimension that facilitates storage of the object in one or more locations and retrieval of the object from the one or more locations.

3. The system of claim 1, wherein the dimension component includes a security dimension that enables management of access to the object and object properties according to a specific user.

4. The system of claim 1, wherein the dimension component includes a version dimension that enables storage and retrieval of the object based on version information, and derivation of a history of changes to the object.

5. The system of claim 1, wherein the dimension component includes a personalization dimension that stores personal information of a user in association with the object.

6. The system of claim 1, wherein the dimension component includes an attributes dimension that enables attribution to a property of the object.

7. The system of claim 1, further comprising a programming interface for interacting with the object, the actual data dimension, and the one or more inherent object dimensions.

8. The system of claim 1, wherein the actual data dimension and one or more inherent object dimensions are added, changed, or modified in realtime.

9. The system of claim 1, further comprising a mapping component that maps object relationships between an in-memory form and a tabular form for storage in a relational database.

10. A computer-implemented multi-dimension object system, comprising:
an object in association with an actual data dimension;
a dimension component that includes one or more inherent object dimensions in association with the object, the actual data dimension and one or more inherent object dimensions are added, changed, or modified in realtime;
a mapping component that maps object relationships between an in-memory form and a tabular form for storage in a database;
a programming interface for interacting with the at least one of the object, the actual data dimension, or an inherent object dimension; and
a processor that executes computer-executable instructions associated with at least the object, dimension component, mapping component, and programming interface.

11. The system of claim 10, wherein the dimension component includes a localization dimension that facilitates storage of the object in one or more locations and retrieval of the object from the one or more locations and a security dimension that enables management of access to the object and object properties according to a specific user.

12. The system of claim 10, wherein the dimension component includes a version dimension that enables storage and retrieval of the object based on version information and a personalization dimension that stores personal information of a user in association with the object.

13. The system of claim 10, wherein the object is searched according to at least one of the actual data dimension or an inherent object dimension.

14. A computer-implemented multi-dimension object method, comprising acts of:
receiving an object and an associated actual data dimension;
associating an additional inherent dimension with the object;
accessing at least one of the object, actual data dimension, or inherent dimension to interact therewith; and
utilizing a processor that executes instructions stored in memory to perform the acts of associating and accessing.

15. The method of claim 14, further comprising adding, changing, or modifying the inherent dimension in realtime.

16. The method of claim 14, further comprising creating and associating with the object an inherent localization dimension that facilitates storage of the object in one or more locations and retrieval of the object from the one or more locations.

17. The method of claim 14, further comprising creating and associating with the object an inherent security dimension that enables management of access to the object and object properties according to a specific user.

18. The method of claim 14, further comprising creating and associating with the object an inherent version dimension that enables storage and retrieval of the object based on version information, and derivation of a history of changes to the object.

19. The method of claim 14, further comprising creating and associating with the object an inherent personalization dimension that stores personal information of a user in association with the object.

20. The method of claim 14, further comprising creating and associating with the object an inherent attributes dimension that enables attribution to a property of the object.
